(19) United States
(12) Patent Application Publication
(10) Pub. No.: US 2026/0140016 A1
(43) Pub. Date: May 21, 2026

(54) LARGE ROLLER BEARING AND METHOD AND DEVICE FOR MONITORING SUCH A LARGE ROLLER BEARING

(71) Applicant: Liebherr-Components Biberach GmbH, Biberach an der Riss (DE)

(72) Inventors: Yvon Ilaka MUPENDE, Neu-Ulm (DE); Johannes WEIMER, Biberach (DE)

(73) Assignee: Liebherr-Components Biberach GmbH, Biberach an der Riss (DE)

(21) Appl. No.: 19/446,799

(22) Filed: Jan. 12, 2026

Related U.S. Application Data
(63) Continuation of application No. PCT/EP2024/069482, filed on Jul. 10, 2024.

(30) Foreign Application Priority Data
Jul. 11, 2023 (DE) 102023118260.9

(51) Int. Cl. G01M 13/04; F16C 19/30

(52) U.S. Cl. CPC G01M 13/04; F16C 19/30; F16C 2233/00

(57) ABSTRACT

The present invention relates to a method for monitoring a roller bearing, in particular in the form of an open-centre large roller bearing, which two is determined by at least one roller bearing row between the bearing rings, wherein different rotational positions of the bearing rings with respect to one another, and different load states in each rotational position, are specified by a control device and rotational-angle-specific and load-specific divergence angles are determined in each case by means of the sensor system in the different rotational positions for the different load states, wherein the determined rotational-angle-specific and load-specific divergence angles are compared with one another by an evaluation device and based on the comparison of the divergence angles a state of wear and/or a remaining service life of the roller bearing is determined.

### CROSS-REFERENCE TO RELATED APPLICATIONS

This application is a continuation of International Patent Application Number PCT/EP2024/069482 filed Jul. 10, 2024, which claims priority to German Patent Application Number DE 10 2023 118 260.9 filed Jul. 11, 2023, which are incorporated herein by reference in their entireties.

### BACKGROUND

The present invention relates to a rolling bearing, in particular in the form of an open-centre large rolling bearing, as well as to a method and an apparatus for monitoring such a rolling bearing, wherein a divergence angle and, if appropriate, additional axial and/or radial clearance between the bearing rings of the rolling bearing are determined by means of a sensor system.

Large rolling bearings have diameters of more than half a meter and are regularly much larger, for example with diameters of more than one meter or more than 1.5 meters, and tend to twist under the naturally very high loads, which is further exacerbated in open-centre designs. Such twisting is caused by uneven loads over the circumference, but above all also by bending loads that are introduced into the rolling bearing, for example when the large rolling bearing supports the superstructure of a construction machine or a crane and high bending moments are introduced into the bearing via the protruding machine arm or crane boom, or corresponding bending moments are introduced into the bearing by the rotor blades of a wind turbine when the latter supports the adjustable rotor blade on the hub or the nacelle of the wind turbine.

If the rings of the rolling bearings diverge and the bearing rings spread out at a divergence angle, this leads to a massive reduction in bearing life. The gaping causes a displacing of the contact point of the respective rolling element with the raceway. This displacing of the contact points leads to an increase in the load peaks, as the raceway no longer conforms to the rolling element in the desired manner, so to speak, so that the service life of the bearing is reduced. In this respect, the frequency of the occurrence of divergence and, in particular, also the size of the divergence angle that occurs can be used to draw conclusions about the excessive bearing load and to estimate the wear or the remaining service life.

Different monitoring systems with various types of sensors have already been proposed for monitoring large rolling bearings. For example, EP 1 528 356 B1 shows a non-contact monitoring system that uses two distance sensors to detect the axial clearance and the radial clearance between the bearing rings and uses this to determine the tilting clearance between the bearing rings. In this case, two distance sensors are used, one of which looks in the axial direction frontally onto a radial surface and another of which looks in the radial direction onto a wedge-shaped circumferential surface.

Other monitoring devices that use non-contact sensor systems to detect axial bearing movements on the one hand and radial bearing movements on the other and compare these with limit values in order to detect excessive bearing wear are known, for example, from the patent document U.S. Pat. Nos. 5,955,880 B1, 5,336,996 B1 and DE 101 07 067 A1.

Although these existing monitoring systems can detect increased bearing clearance quite accurately, they have a relatively difficult time distinguishing between normal, uniform wear on the one hand and atypical, non-uniform wear on the other and predicting the actual remaining service life at least reasonably accurately. In particular, the previously known systems cannot detect and estimate the bearing impairments associated with the gaping of the bearing rings with sufficient precision.

It is therefore the underlying object of the present invention to provide an improved rolling bearing, an improved method and an improved apparatus for monitoring it, in each case of the type mentioned at the beginning, which avoid the disadvantages of the prior art and further develop the latter in an advantageous manner. In particular, a more precise and differentiated monitoring of bearing deformations and their effect on bearing wear is to be provided without the need for excessively complex investigations and sensor systems.

### SUMMARY

Said object is achieved by a method according to claim 1, an apparatus according to claim 6 and a rolling bearing according to claim 7. Preferred embodiments of the invention are the subject-matter of the dependent claims.

According to a first aspect, it is therefore proposed to move the rolling bearing into different defined rotational positions and to subject it to different load states and to determine the divergence angles that are set in this case. According to the invention, it is provided that different rotational positions of the bearing rings with respect to one another and different load states in each rotational position are specified by a control device and rotational-angle-specific and load-specific divergence angles are determined in each case in the different rotational positions for the different load states by means of the sensor system, wherein the rotational-angle-specific and load-specific divergence angles determined are compared with one another by an evaluation device and a state of wear and/or a remaining service life of the rolling bearing is determined based on the comparison of the divergence angles.

By considering different rotational positions and different specified load states in the different rotational positions, uneven gaping and thus atypical, uneven wear can be determined more precisely and better distinguished from normal, uniform wear. Simultaneously, by determining the divergence angles in the different rotational positions, it is possible to better estimate the unusual load peaks to which the bearing rings are subjected and the wear they show.

Preferably, the control device can be configured to specify at least one radial load condition and at least one tilting load condition with the different rotational positions. In the radial load condition, the rolling bearing is specifically subjected to a radial load that acts on the rolling bearing substantially perpendicular to the axis of rotation of the rolling bearing or attempts to displace the bearing rings against one another in the radial direction. Advantageously, said radial force or radial load can be the only load in the radial load condition, or more specifically, substantially the only load acting on the bearing in addition to the installation-related bearing loads. Depending on the installation condition, the rolling bearing has to support typical installation loads, for example the weight of an installation environment supported by the rolling bearing, such as the weight of a superstructure of a construction machine or a crane, which also act when the rolling bearing and the installation environment mounted in it are idle or stationary, so to speak. In the specified radial load condition, said radial load is applied to the bearing in addition to these installation-related loads in order to be able to measure the relative movement of the bearing rings to one another as a result of this additional radial load by means of the sensor system.

Similarly, a specific tilting moment is applied to the rolling bearing in the specified tilting load condition, wherein said tilting moment can also preferably be the only additional load in addition to the installation-related bearing loads.

Preferably, the control device specifies said radial load and tilting load conditions online, so to speak, while the bearing is installed in its intended installation environment. In particular, the additional radial load and the additional tilting moment can be generated in machine movements or actuations specified by the control device. For example, if the rolling bearing is used as a slewing bearing of a construction machine that supports the superstructure of the construction machine, the traveling gear of the undercarriage can be blocked or braked and the superstructure can be subjected to a targeted horizontal force. If the construction machine is an excavator, for example, the crawler undercarriage or the wheeled undercarriage can be braked and the excavator shovel can be driven into the ground or anchored to it and propulsion can be generated by actuating the excavator arm so that the superstructure and undercarriage are displaced against each other in a horizontal direction.

To apply the additional tilting moment for the specified tilting load condition, for example, a predetermined weight can be mounted on the protruding machine arm or a predetermined load can be attached or increased on the jib of a crane. If necessary, it may also be sufficient to bring the machine arm, for example an excavator arm, into a protruding position so that the rolling bearing is subjected to a corresponding tilting moment by the dead weight of the protruding machine arm.

In a further development of the invention, the divergence angles determined in the different rotational positions under different loading conditions can be compared with one another and/or with reference values for this in different and/or several times in order to be able to draw conclusions about the state of wear or the remaining service life. In particular, for example, the divergence angles detected in the different rotational positions under the specified radial load condition can be compared with each other. If in this case, for example, a significantly higher divergence angle occurs in one rotational position than in the other rotational positions, although the same radial load was applied, it is possible to draw conclusions about atypical, uneven wear.

If the installation environment may have different stiffnesses, it makes sense to take their influence into account in said adjustment, for example by adapting the reference values for the divergence angle, e.g. in the form of permissible maximum values, to the stiffness of the installation environment or taking this into account. This can be done, for example, by deductions and additions from/to standard values for the reference values that take the installation environment into account. If, for example, the bearing is installed rigidly on all sides so that the installation environment mitigates torsion of the bearing rings under one-sided loads, the standard reference value for a critical divergence angle can be reduced by a discount of, for example, 25% or 33%, as a smaller divergence angle should occur in such an installation situation as long as the bearing itself is fine. Conversely, an unstable or yielding installation environment can be taken into account in the opposite way.

Alternatively, or additionally, the reference values can be adapted to partially different installation environments, e.g. to installation environments with different stiffnesses in different directions or in different portions. If, for example, the divergence angles are determined in different rotational positions with respect to which the installation environments have different stiffnesses, the reference values for the different rotational positions can be adapted accordingly, e.g. reduced for positions with high ambient stiffness and increased in positions with low ambient stiffnesses.

In a similar manner, the divergence angles determined in the different rotational positions under the tilting load conditions can be compared with one another. If a significantly increased divergence angle occurs in one or, for example, two rotational positions, although the same tilting load was applied in the other rotational positions, an atypical, uneven wear can also be concluded. Alternatively, or additionally, the detected divergence angles can also be compared with predetermined reference values, wherein the reference values can also be adapted to or take into account the installation environment as just mentioned. If there are unequal or excessive deviations of the folding angle from the respective reference value, it can be concluded that there is atypical wear.

The comparison of the divergence angles against each other can be combined with the comparison against reference values, e.g. in such a manner that larger deviations from each other are still tolerated if the reference values are clearly adhered to and vice versa. On the other hand, it is also possible to draw conclusions about atypical wear if adjustments are still permissible per se, but both are close to the permissible borders. The mutual consideration of the adjustments allows an overall refined determination of atypical wear to be achieved.

Alternatively or additionally, the divergence angles in the radial load condition on the one hand and in the tilting load condition on the other hand in the individually rotational positions can be compared with one another and/or with reference values in order to determine whether the deviation of the divergence angles under different loading conditions in one or the other rotational position exceeds a predetermined threshold value, so that an atypical wear can then be inferred due to an excessive deviation of the divergence angles.

Alternatively, or additionally, it can also be checked whether the deviations of the divergence angles, which have been determined under the radial load condition on the one hand and under the tilting load condition on the other, deviate from one another and/or from reference values to different degrees in the different rotational positions. If, for example, there is a significantly higher or significantly lower deviation in one or two rotational positions than in the other rotational positions, it may be possible to conclude that there is increased wear or a shortened remaining service life.

In a further development of the invention, not only the divergence angle between the bearing rings, but also axial clearance and/or radial clearance between the bearing rings or axial movements and/or radial movements can be determined by means of the sensor system in the different rotational positions if the rolling bearing is subjected to different load states in said manner.

The evaluation device can also be configured to take into account the determined rotation angle and load condition-specific axial clearances and/or radial clearances in addition to the divergence angle when determining the remaining service life or the state of wear.

In this case, consideration can be given in different ways. For example, the axial clearances and/or radial clearances specific to the angle of rotation and load condition can be used as an independent criterion for determining excessive wear or a shortened remaining service life, irrespective of the divergence angle. For example, axial clearances detected in the different specified rotational positions can be compared with each other and, if excessive axial clearance occurs in one rotational position or if there is excessive deviation of the axial clearance in one rotational position from the axial clearances in the other rotational positions, it can be concluded that there is increased wear or a shortened remaining service life. The radial clearances specific to the angle of rotation and load condition can be evaluated in a similar manner.

However, the axial and/or radial clearances in the various rotational positions and load conditions can also be taken into account in conjunction with the specific divergence angles for determining the wear condition and the remaining service life. For example, an increased state of wear or a shortened remaining service life can be assumed if, in one of the specified rotational positions, not only does the divergence angle occurring there and/or its deviation from the divergence angles in other rotational positions exceed or fall below a predetermined threshold value, but also at least the axial clearance occurring in said rotational position and/or the radial clearance determined there and/or its deviation from the radial and/or axial clearances occurring in the other rotational positions exceeds or falls below a predetermined threshold value.

The sensor system for determining the divergence angle and/or the axial and/or radial clearances or movements can be configured in different manners. For example, distance sensors can be used to determine the size of a bearing gap between the bearing rings at different points in order to determine the tilting angle or axial clearance and/or radial clearance from the gap widths of the bearing gap at predetermined portions of the bearing gap determined by the distance sensors and the known geometry of the bearing rings.

According to a further aspect of the invention, however, the sensor system can also comprise a plurality of inclination sensors, wherein at least one inclination sensor is mounted on each of the bearing rings and the evaluation device is configured to determine the divergence angle from the inclination signals of the inclination sensors determined on both bearing rings. In particular, the divergence angle can be calculated from a difference in the inclination angles detected at the two bearing rings by the inclination sensors mounted there. If it is assumed that the bearing rings do not diverge, but are exactly concentric to each other as intended or show no splay, it can be assumed that the bearing rings have the same inclination in space. If the bearing rings or certain portions of the bearing rings have different orientations in space or inclinations in relation to the vertical or horizontal, it can be assumed that the different orientations or inclinations are caused by gaping.

In a further development of the invention, several inclination sensors can be mounted on at least one or each of the bearing rings, which can be arranged in different sectors or distributed over the circumference in order to be able to determine the inclination in different bearing ring sectors. By detecting the bearing ring inclination sector by sector, deformations can be detected particularly precisely and divergence angles can be set more specifically in different sectors. In addition, it can also be ensured in different rotational positions that an inclination sensor is present in a bearing ring sector that is expected to show the largest divergence angle in order to be able to precisely measure the inclination there.

In this case, the inclinations detected in the different sectors of a bearing ring can be compared with one another or the divergence angles in neighboring or bordering sectors of different bearing rings can be compared with one another, for example to reduce a remaining service life or to assume an increased state of wear if a threshold value is exceeded.

Alternatively, or additionally, according to a further aspect of the invention, the sensor system may also comprise one or more triangulation sensor units which determine the divergence angle of a bearing gap between the two bearing rings by means of triangulation of a measurement signal.

For example, such a triangulation sensor unit can have two signal emitters and two signal receivers, wherein the two signal emitters are each mounted on one of the bearing rings and throw a signal onto a contour of the other bearing ring on the other side of the bearing gap. The signal receivers are also mounted on one of the bearing rings and can receive the signal transmitted or reflected by the opposite bearing ring and determine its direction and/or its point of impact in order to determine the divergence angle between the two bearing rings from the two signal angles by triangulation.

In particular, two pairs of emitter-receiver sensor systems can be mounted on one bearing ring and two signals can be sent to an opposite contour of the other bearing ring on the opposite side of the gap and the emitted or reflected signal can be received and determined with regard to the signal angle between the emitted signal and the reflected signal, so that the divergence angle can be determined from the possibly different signal angles.

Preferably, the opposite contour of the other bearing ring, onto which the signal is thrown and from which it is reflected, has an arc-shaped contour, for example a circular arc-shaped cylindrical contour and/or a spherical cap-shaped contour, wherein other contours such as elliptical contours are also possible. In this case, the signal emitters can be aligned in such a way that they emit signals in parallel with a transverse offset and thus throw them onto different portions of the arcuately contoured reflection contour so that, depending on the divergence of the bearing rings, the signal angles between the emitted signals and the reflected signals deviate greatly from each other, from which signal angles the divergence angle can then be determined.

Such a triangulation sensor unit can be installed in a very space-saving manner and does not require separate installation locations spaced apart from one another for different sensor systems. Nevertheless, the divergence angle can be determined very precisely.

### BRIEF DESCRIPTION OF THE DRAWINGS

The invention is explained in more detail below with reference to preferred embodiments and the corresponding drawings. The drawings show:

FIG. 1: a rolling bearing comprising a monitoring device according to an advantageous embodiment of the invention, wherein different rotational positions and bearing loads for the rolling bearing can be specified by a control device and load-specific divergence angles are determined in the different rotational positions by means of a sensor system,

FIG. 2: a half-section through the rolling bearing from FIG. 1, showing the divergence angle between the two bearing rings and the sensor systems mounted on the bearing rings in the form of inclination sensors,

FIG. 3: a half-section through the rolling bearing of FIG. 1, showing the divergence angle between the two bearing rings and the sensor system for determining the divergence angle in the form of a triangulation sensor unit, wherein the triangulation sensor unit is also shown in an enlarged, sectional view in order to show the signal emitters and signal receivers arranged in pairs more clearly,

FIG. 4: a half-section through the rolling bearing from FIG. 1, which shows the divergence angle between the two bearing rings and the sensor system in the form of two distance sensors, by means of which the divergence angle can be determined,

FIG. 5: a view of the screen control of the control device for specifying different rotational positions in the determination of the divergence angle, wherein partial view a) specifies a rotational position of 0°and partial view b) specifies a rotational position of 180°, and

FIG. 6: a menu representation of the control device for specifying the bearing load conditions for determining the divergence angle, wherein partial view a) specifies a tilting and axial load condition and partial view b) specifies a radial load condition.

### DETAILED DESCRIPTION

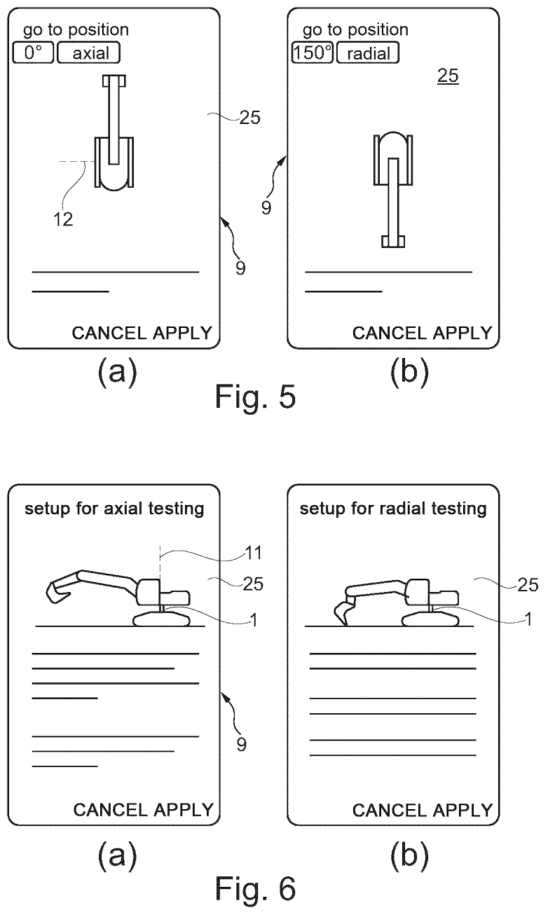

As shown in FIGS. 5 and 6, the rolling bearing 1 can, for example, form the slewing bearing of a construction machine, for example in the form of an excavator, wherein the slewing bearing can rotatably support the superstructure or the slewing platform of the construction machine on its undercarriage about an upright axis of rotation. In the case of the excavator, the undercarriage is provided with a crawler chassis and the rotatably mounted superstructure carries an articulated arm with an excavator bucket on it.

Said rolling bearing 1 can be configured in the form of an open-centre large rolling bearing, wherein one of the two inner and outer rings 2, 3, which can be rotated relative to each other, can be provided with a toothing 20 in order to be rotated relative to the other ring by a slewing gear drive not specifically shown, cf. FIGS. 2 to 4.

The inner and outer rings 2, 3 are rotatably supported against each other by one or more roller bearing rows, wherein for example two axial bearing rows 5, 6 and one radial bearing row 4 can be provided between the inner and outer rings 2, 3, cf. for example FIG. 2. Said axial and radial bearing rows 4, 5, 6 can for example be arranged in the bearing gap around an annular lug, with which one of the bearing rings can enter into an annular groove of the other bearing ring, cf. FIG. 2. For example, two axial bearing rows 5, 6 can be supported on opposite, radially extending edges of the annular lug 21, while the radial bearing row 4 can be arranged on the circumferential surface of the annular lug 21 between the two axial bearing rows 5, 6, cf. FIG. 2.

As shown in FIG. 2, large loads, for example in the form of tilting moments and/or axial loads distributed unevenly over the circumference and possibly also favored by wear, can lead to bearing ring deformations or tilting, so that a divergence angle β opens up between the inner ring 2 and the outer ring 3, cf. FIGS. 2 to 4. In this case, said divergence angle β describes the splay angle between two opposing circumferential surfaces of the inner and outer rings 2, 3, which should be aligned coaxially to each other and each extend in parallel to the axis of rotation. For example, the divergence angle β can be observed at an axial end portion of the bearing rings 2, 3, in that an outer circumferential surface of the inner ring 2 and an inner circumferential surface of the outer ring 3 are opposite each other, cf. FIG. 2.

Insofar as FIG. 2 shows only one example, it should be made clear that inner and outer rings 2, 3 can also be interchanged, i.e. in a different bearing arrangement, 2 would be the outer ring and 3 the inner ring. The arrangement of the sensor components described below could then be reversed accordingly, i.e. a component described on the outer ring can be on the inner ring and a component described on the inner ring can be on the outer ring.

Said divergence angle β could, however, also be observed on an opposite side of the bearing rings, for example on the upper edge portion side as shown in FIG. 2, but there it is more difficult, as the bearing is pushed together there or tilts closer together. Looking at FIG. 2, for example, said divergence angle β could also be observed between two opposite, at least approximately radially extending annular surfaces of the inner and outer rings 2, 3, for example between the raceways of the axial bearing rows 5, 6. As shown in FIG. 2, the two raceways of the inner ring 2 for the two axial bearing rows 5, 6 gape open with respect to the two raceways of the axial bearing rows 5, 6, which are provided on the annular lug 21 of the outer ring 3. Similarly, said divergence angle β can also be observed on the raceways of the radial bearing row 4 extending-approximately-in the circumferential direction or extending axially, cf. FIG. 2.

Said divergence angle β is a measure of the unwanted or unnatural tilting or inclination of the associated raceway surfaces of a row of bearings, which results in the rolling elements no longer having the predetermined contact points or contact lines with the raceways, as the contact point is displaced by the divergence angle β. Looking, for example, at FIG. 2, where the upper and lower axial bearing rows 5 and 6 are shown, the divergence angle β causes the rolling elements, which are cylindrical in themselves, to be cantilevered. The divergence angle β also results in edge support in the radial bearing row 4.

However, such a displacing of the contact point does not only occur with flat raceways or cylindrical rolling elements, but can also occur with curved raceways of, for example, barrel bearings or ball bearings or also with tapered roller bearings and raceways that are tapered in relation to each other.

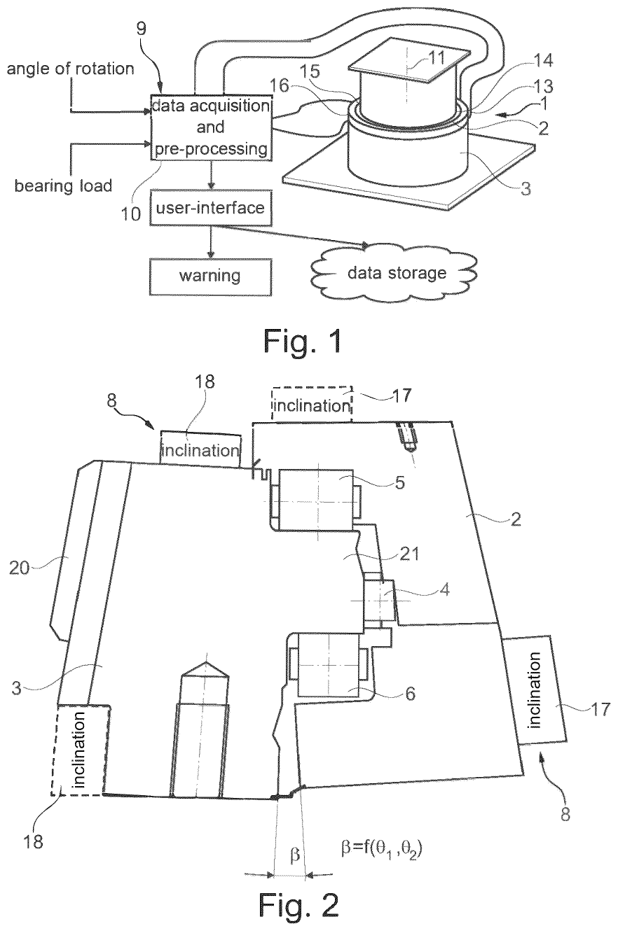

To determine said divergence angle β, a sensor system 8 is provided, which preferably has several sensor elements that can be placed in different sectors distributed over the circumference of the bearing rings, cf. FIG. 1, for example, in which a total of four sensor elements are arranged in opposite sectors. However, sensor systems can also be arranged in four opposing quadrants, for example, in order to be able to determine deformations or divergence angles even more precisely.

As shown in FIG. 2, the sensor system 8 can have inclination sensors 17, 18 as sensor elements, which can detect the inclination in absolute terms in space and/or determine an inclination with respect to one another. Preferably, at least one of the inclination sensors 17 is mounted on the inner ring 2 and one of the inclination sensors 18 is mounted on the outer ring 3, cf. FIG. 2, wherein, for example, one of said inclination sensors can be mounted on a circumferential surface and one of the inclination sensors can be mounted on an axial surface of the bearing rings. Preferably, one of the sensors can be mounted on the circumferential side and one of the sensors on the end-face side, wherein, however, one sensor can also be mounted on the inner and outer ring 2, 3 on the inner circumferential side and one sensor on the end-face side, cf. FIG. 2, where the additional inclination sensors are shown as dashed lines. Said inclination sensors 17, 18 determine the respective inclination θ1 or θ2 of the inner ring 2 on the one hand and the outer ring 3 on the other, so that the divergence angle β can be determined by comparing, in particular by forming the difference between the measured inclinations θ1 and θ2.

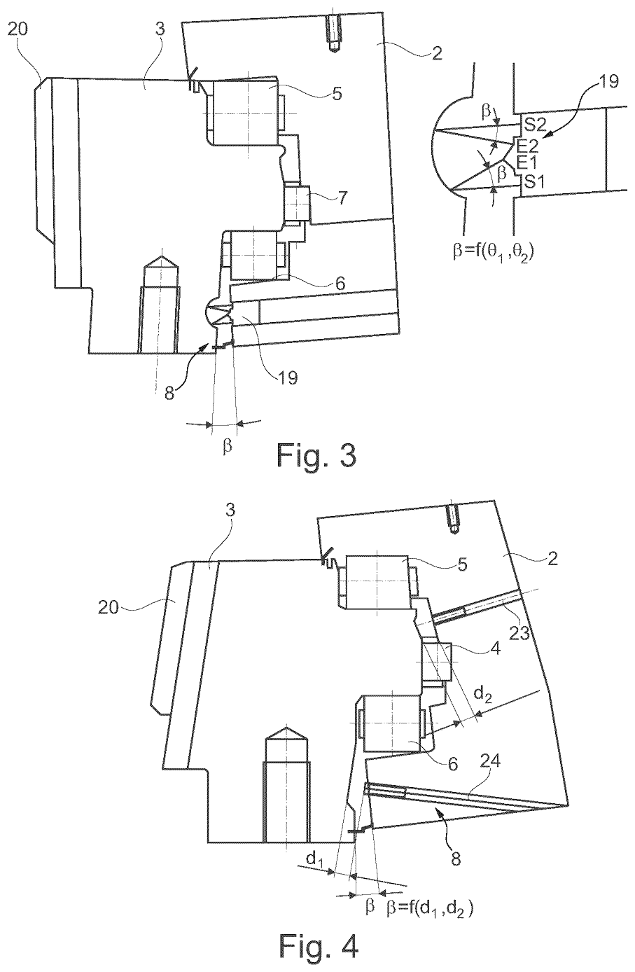

As shown in FIG. 3, the sensor system 8 can-alternatively or in addition to the inclination sensors 17, 18—also have one or more triangulation sensor units 19 arranged distributed over the circumference, which determine the divergence angle β between the inner and outer rings 2, 3 by triangulation.

As the enlarged detailed view of FIG. 3 makes clear, each of said triangulation sensor units 19 can each have two transmitters or signal emitters S1, S2, each of which emits a signal from one of the bearing rings and throws it onto an opposite surface of the other bearing ring. For example, both signal emitters S1, S2 can be arranged on the same bearing ring, for example on the inner ring 2, and project the signal onto the other bearing ring, for example the outer ring 3, wherein the signal emitters S1, S2 can be arranged in such a manner that they emit their signals in a radial direction without a divergence angle.

The opposite contour surface of the other bearing ring, which according to FIG. 3 is the outer ring 3, can preferably have a curved contour, in particular a curved contour when viewed in cross-section. As FIG. 3 shows, in particular a concave contour viewed in cross-section can lie opposite the two signal emitters S1, S2, wherein the curved counter-contour 22 can extend circumferentially, for example in the form of an annular groove in one of the bearing rings, for example the outer ring 3, wherein said annular groove can have a circular or circular arc-shaped contoured base.

The signal emitted by the signal emitters S1, S2 onto the mating contour 22 is reflected by the mating contour 22 and received by the signal receivers E1, E2 of the triangulation sensor unit 19, wherein depending on the tilting of the bearing rings relative to each other, the point of impact moves, so to speak, or a different signal angle θ1, θ2 is set, cf. FIG. 3. The divergence angle β can be determined from the signal angles θ1 and θ2 determined by the triangulation sensor unit 19.

As shown in FIG. 4, the sensor system 8 can—alternatively or in addition to the inclination sensors 17, 18 and/or the triangulation sensor unit 19—also comprise non-contact distance sensors 23, 24, cf. FIG. 4.

Advantageously, said distance sensors 23, 24 can measure the distance between the two bearing rings 2, 3 in the area of the bearing gap, wherein, for example, both distance sensors 23, 24 can measure a radial distance between the bearing rings 2, 3, advantageously in areas spaced apart from one another in the axial direction, for example once below all bearing rows and once in the area between an upper and a second upper bearing row, cf. FIG. 4.

Due to the divergence angle β, the inner and outer rings 2, 3 are displaced from each other so that the radial gap dimension changes differently at different points, for example below the rows of bearings by the dimension d2 and in the upper area by the dimension d1. The divergence angle β can be determined from the differences in the radial distances d1, d2 and the known bearing geometry from said radial distances d1, d2.

It would also be conceivable, as an alternative or in addition to the radial distance sensors shown, to detect the axial distance between the bearing rings at characteristic points of the bearing gap, depending on how the bearing gap geometry is configured.

As illustrated in FIG. 1, several sensor elements 13, 14, 15, 16 can be arranged distributed over the circumference in different sectors or quadrants of the inner and outer rings 2, 3 in order to be able to determine the divergence angle β from the different inclination and/or triangulation and/or distance signals in the different sectors or quadrants.

Here, different rotational positions of the bearing rings 2, 3 with respect to one another and different load states in each rotational position are specified by a control device 9, cf. FIG. 1 and FIGS. 5 and 6, and rotational-angle-specific and load-specific divergence angles β are then determined for the different load states by means of the sensor system 8 in the different rotational positions.

As illustrated in FIG. 5, the control device 9 can, for example, specify different rotational positions of the rolling bearing 1 on a display 25, for example by indicating the rotational position by angles of 0° and 180° and/or by a pictorial view of the implement or the machine, for example by displaying the position of the machine arm.

The respective rotational position of the rolling bearing 1 can then be started up automatically, for example by tapping the display or also by manually actuating control elements such as a joystick. In the example shown in FIG. 5, for example, the “Apply” button on the touchscreen can be actuated.

In order to implement the different loading conditions of the rolling bearing in the respective rotational position, the control device 9 can specify corresponding machine positions and/or configurations. In the example of the excavator, for example, an approximately horizontally protruding position of the bucket arm can be specified to achieve a tilting moment on the slewing ring bearing, cf. FIG. 6a. In order to realize a radial load on the slewing ring bearing, the excavator bucket can be driven into the ground or anchored to it and the undercarriage drive can be actuated simultaneously, for example by driving backwards. Conversely, the traveling gear can also be braked and the excavator bucket actuated to pull the device forward, so that the braked traveling gear elements result in a radial reaction load on the slewing ring bearing, cf. FIG. 6b.

The control device 9 can also work semi-automatically or fully automatically here. For example, after displaying the respective load situation as shown in FIG. 6a or 6b, the “Apply” button shown on the touchscreen can be pressed to apply the load.

Simultaneously, the control device 9 establishes the data acquisition by the sensor system 80, cf. FIG. 1.

The data detected by the sensor system 8 and/or the divergence angle β derived from this can be displayed and/or forwarded via a user interface, for example in the form of a tablet or a display in the machine control system or a cell phone, for example to a data storage device. After data evaluation, a warning signal can also be emitted if a remaining service life has become dangerously short or a certain state of wear has occurred.

We claim:

1. A method for monitoring a rolling bearing comprising an open-centre large rolling bearing comprising at least one roller bearing row between bearing rings, the method comprising:
specifying by control device different rotational positions of the bearing rings with respect to one another and different load states in each rotational position;
determining by a sensor system rotational-angle-specific and load-specific divergence angles in the different rotational positions for the different load states;
comparing by an evaluation device the rotational-angle-specific and load-specific divergence angles determined are compared with one another and/or with at least one predetermined reference value; and
determining a state of wear and/or a remaining service life of the rolling bearing based on the comparison of the divergence angles.

2. The method of claim 1, wherein a radial load condition, in which the rolling bearing is loaded with a predetermined radial load, exclusively with a radial load in addition to installation-related bearing loads, perpendicular to the axis of rotation of the rolling bearing, and furthermore a tilting load condition, in which the rolling bearing is loaded with a tilting moment, exclusively with a tilting moment in addition to the installation-related bearing loads, around a tilting axis transverse to the axis of rotation of the rolling bearing, are specified by the control device in each of the predetermined rotational angle positions, and
a divergence angle in the radial load condition and a divergence angle in the tilting load condition in each rotational position are determined by the sensor system, wherein, by the evaluation device, the divergence angles in the radial load conditions in the different rotational positions are compared with one another and/or with at least one radial load reference value and the divergence angles under the tilting load conditions in the different rotational positions are compared with one another and/or with at least one tilting load reference value, and the divergence angles under the radial and tilting load conditions in each rotational position are additionally compared with one another and/or with at least one reference value and, based on the comparison, the state of wear and/or the remaining service life of the rolling bearing is determined.

3. The method of claim 2, wherein the rotational-angle-specific and load-specific divergence angles determined are compared by the evaluation device with a plurality of reference values, which comprise different reference values for different rotational angles and/or different reference values for different loading conditions, and a state of wear and/or a remaining service life of the rolling bearing is determined based on the comparison of the divergence angles.

4. The method of claim 3, wherein the determined rotational-angle-specific and load-specific divergence angles are compared both with one another and with rotational-angle-specific and load-specific reference values by the evaluation device and a state of wear and/or a remaining service life of the rolling bearing is determined based on the comparison of the divergence angles, wherein the evaluation device takes into account an interaction of the comparison of the rotational-angle-specific and load-specific divergence angles with one another and the comparison of the rotational-angle-specific and load-specific divergence angles with rotational-angle-specific and load-specific reference values to determine the state of wear, smaller or good deviations in the one comparison compensate for or mitigate larger or bad deviations in the other comparison.

5. The method of claim 4, wherein, in addition to the divergence angles, by the sensor system, for different rotational positions for different load states, rotational-angle-specific and load-specific axial and/or radial clearances between the bearing rings are determined in each case, wherein the axial and/or radial clearances determined are compared with one another by the evaluation device and the state of wear and/or the remaining service life of the rolling bearing is determined based on the comparison of the divergence angles and the axial and/or radial clearances.

6. The method of claim 5, wherein the axial clearance and the radial clearance in the radial load condition as well as the axial clearance and the radial clearance in the tilting load condition are determined by the sensor system in each rotational position, wherein, by the evaluation device, the axial clearances under the radial load condition in the different rotational positions are compared with one another and the radial clearances under the radial load condition in the different rotational positions are compared with one another and the axial clearances under the tilting load condition in the different rotational positions are compared with one another, and the axial clearances under the tilting load condition in the different rotational positions are compared with one another, and on the basis of the comparison of the divergence angles, the axial clearances and the radial clearances, the state of wear and/or the remaining service life of the rolling bearing is determined.

7. The method of claim 6, wherein the divergence angles in the different rotational positions are evaluated by the evaluation device for deviations from one another and/or from at least one reference value and an unnatural state of wear and/or a shortened remaining service life is determined if the deviations of the divergence angles in the different rotational positions from one another and/or from the at least one reference value exceed a predetermined threshold value.

8. The method of claim 7, wherein the at least one reference value and/or the permissible deviation of the rotational-angle-specific and load-specific divergence angles from one another is adapted to the stiffness of the installation environment by the evaluation device by selectable addition and/or deduction factors.

9. The method of claim 8, wherein the at least one reference value is automatically initialized or determined by calculation by the evaluation device during putting into operation of the monitoring of the rolling bearing.

10. An apparatus for monitoring a rolling bearing, comprising:
a sensor system for determining a divergence angle between the bearing rings of the rolling bearing;
an evaluation device for evaluating the sensor signals of the sensor system; and
a control device for specifying different rotational positions of the bearing rings with respect to one another and different load states in each rotational position;
wherein the evaluation device is configured to evaluate the rotational-angle-specific and load-specific divergence angles determined by the sensor system in the different rotational positions for the different load states and to compare them with one another and/or with at least one reference value, and on the basis of the comparison, to determine a state of wear and/or the remaining service life of the rolling bearing.

11. A rolling bearing comprising:
an open-centre large rolling bearing, comprising:
two bearing rings rotatable relative to one another and supported against one another by at least one roller bearing row;
a sensor system for determining a divergence angle between the bearing rings, and
an evaluation device for evaluating the sensor signals of the sensor system;
a control device for specifying different rotational positions of the bearing rings with respect to one another and different load states in each rotational position;
wherein the evaluation device is configured to evaluate the rotational-angle-specific and load-specific divergence angles determined by the sensor system in the different rotational positions for the different load states and to compare them with one another and/or with at least one reference value, and on the basis of the comparison, to determine a state of wear and/or the remaining service life of the rolling bearing.

12. The rolling bearing of claim 11, wherein the sensor system comprises sensor elements arranged in different sectors for determining the divergence angles in different sectors of the rolling bearing, which are arranged distributed around the axis of rotation thereof, wherein the evaluation device is configured to compare the divergence angles occurring in the different sectors and determine the state of wear and/or the remaining service life of the rolling bearing based on the comparison of the divergence angles in the different sectors.

13. The rolling bearing of claim 12, further comprising at least four sensor elements in at least four sectors opposite one other in pairs and are configured to determine the divergence angles in said at least four sectors.

14. The rolling bearing of claim 13, wherein the sensor system comprises a plurality of inclination sensors, wherein at least one inclination sensor is on each of the bearing rings and the evaluation device is configured to determine the divergence angle from the inclination signals determined on both bearing rings.

15. The rolling bearing of claim 14, wherein the sensor system comprises at least one triangulation sensor unit configured to determine the divergence angle at the bearing gap between the two bearing rings by triangulation of a measurement signal.

16. The rolling bearing of claim 15, wherein the at least one triangulation sensor unit comprises two signal emitters and two signal receivers, wherein the signal emitters are each mounted on one of the bearing rings and are configured to project a signal onto a curved, arcuate-or spherical-cap-shaped, contour of the other bearing ring, and the signal receivers are configured to receive reflected signals and determine the angles between the emitted signals of the signal emitters and the received reflected signals.

17. The rolling bearing of claim 16, wherein the signal emitters are perpendicular to a central plane of the bearing gap.

18. The rolling bearing of claim 17, wherein the sensor system has at least one distance sensor configured to determine the distance of at least two contour portions of the bearing rings from one another, and wherein the evaluation device is configured to determine the divergence angle from the distance signals determined at both bearing rings.

19. The rolling bearing of claim 18, wherein the sensor system comprises at least two different sensor types from the group inclination sensor, triangulation sensor unit and distance sensor.
